(19) United States
(12) Patent Application Publication
(10) Pub. No.: US 2012/0110823 A1
(43) Pub. Date: May 10, 2012

(54) SMOOTH LINEAR SEPARATION DEVICE BETWEEN A FIRST PART AND A SECOND PART

(75) Inventor: Jacques Behar, Saint Medard en Jalles (FR)

(73) Assignee: ASTRIUM SAS, Paris (FR)

(21) Appl. No.: 13/381,156

(22) PCT Filed: Jul. 8, 2010
(86) PCT No.: PCT/EP2010/059776

§ 371 Date: Dec. 28, 2011

(30) Foreign Application Priority Data
Jul. 9, 2009 (FR) 0954777

(51) Int. Cl. B23P 25/00

(52) U.S. Cl. 29/428; 29/722

(57) ABSTRACT

A device for smooth linear separation between a first part and a second part. The first part is linearly connected to the second part. The device includes a heat source applied onto the first part that applies a heat stimulus to the first part so as to separate the first part from the second part by thermal deformation of the first part.

### TECHNICAL FIELD

The invention relates to a device for smooth linear separation between a first part and a second part, the first part being connected to the second part, comprising a heat source applied onto the first part that applies a heat stimulus to the first part so as to separate the first part from the second part by thermal deformation of the first part.

Such mechanically connected assemblies are used in space launchers (separation of stages, payload), missiles, space probes or even aircraft (to release payload).

These applications are characterised by the fact that there is a need to separate objects that may be fragile, for example a satellite, and in which the connection has to resist high mechanical loads, for example during launcher boost phases.

Currently known separation devices include point connections, for example explosive bolts, and linear connections. The invention is more particularly applicable to a separation device of the linear type.

Mechanical linear connections have already been disclosed, for example in document FR 2 839 550. However, most solutions applied to the linear connections are pyrotechnic, as disclosed in document FR 2 861 691. A pyrotechnic cord is used which, when inflamed, creates an overpressure that deforms and breaks the selected rupture zone. There is a pyrotechnic effect with the generation of a frequently violent shock.

All solutions using a pyrotechnic rupture necessarily cause very strong shock waves that can be damaging to the launcher and its payload to the extent that additional shock absorber systems are sometimes installed, like those disclosed in document FR 2 861 691.

Soft mechanical separations are also known as disclosed in patent documents U.S. Pat. No. 4,753,465, U.S. Pat. No. 5,312,152 and FR 2 685 399. However, these separation devices are not linear. They are screw-nut type point devices. They have zero dimension.

Consequently, the purpose of the invention is a soft linear separation device and method, for example enabling the separation of launcher stages and limiting shocks on the launcher and its payload.

These purposes are achieved according to the invention by the fact that the first part is linearly connected along a line to the second part and by the fact that the heat source is applied linearly along a line onto the first part.

Due to these characteristics, the result is a connection along a line, for example along a straight line or a circle. The connection is linear. It is single-dimensional. It is used to attach two cylinders and is applicable to the separation of rocket stages.

Preferably, the heat source is placed in a gas tight cavity with sides comprising thermal insulation on at least two sides of the cavity.

Also preferably, the thermal insulation is made with materials with the lowest possible diffusivity, the diffusivity being the magnitude λ/ρ.Cₚ in which λ is the conductivity of the material; ρ is its density and Cₚ is its calorific capacity.

The thermal insulation is made for example of mica or Prosial®.

For example, the heat source may be a heating chemical composition.

For example, the heating chemical composition may be a commercial Thermite with a calorific value of at least 850 cal/g.

Advantageously, the first part is separated from the second part within a time less than 10 seconds and preferably less than 3 seconds.

In one particular embodiment, the first part is an axisymmetric part and the second part is a cylinder linearly connected to the first part by pins at a spacing from each other, by detachable gluing or by brazing.

Advantageously the first part comprises splices that will facilitate its deformation.

The invention also relates to a soft linear method for separating a first part from a second part, the first part being linearly connected to the second part. This method comprises the following successive steps:

a heat source is applied onto the first part;

the first part is heated by means of the heat source so as to be deformed by it thermally and to separate from the second part.

According to the method, the first part is preferably an axisymmetric part and the second part is a cylinder linearly connected to the first part by pins at a spacing from other, or by detachable gluing or brazing.

The device according to the invention is applicable to space launchers, space probes, satellites and missiles.

Other characteristics and advantages of this invention will become clear after reading the following description of an example embodiment given for illustrative purposes with reference to the appended drawings. On these figures:

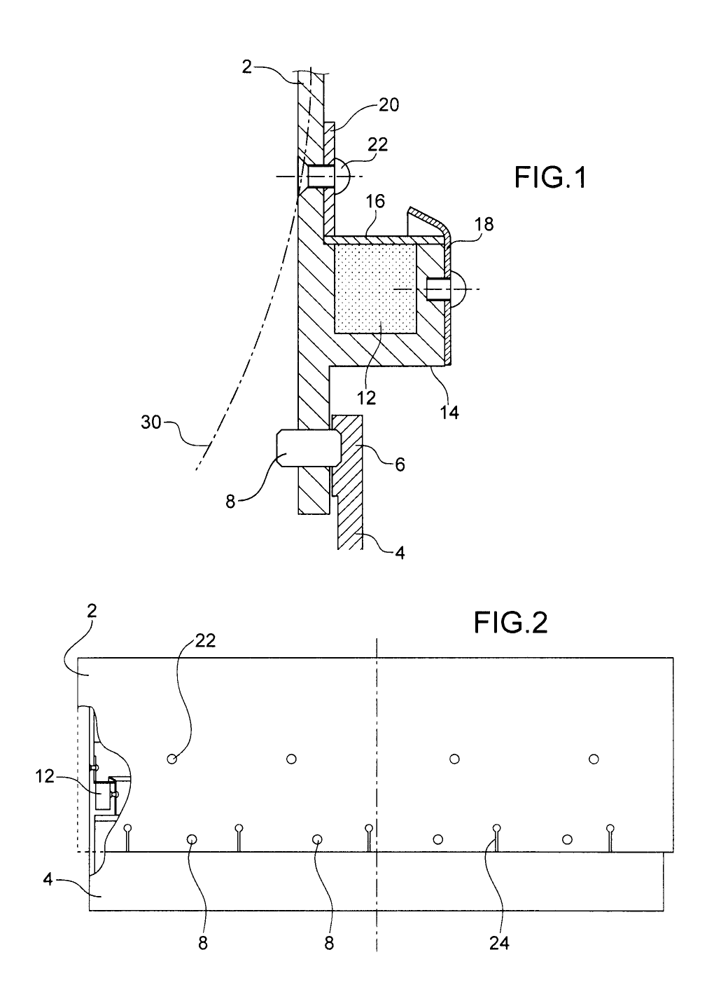

FIG. 1 is a sectional view of an example architecture of a separable connection according to this invention;

FIG. 2 is an elevation view of the device shown in FIG. 1;

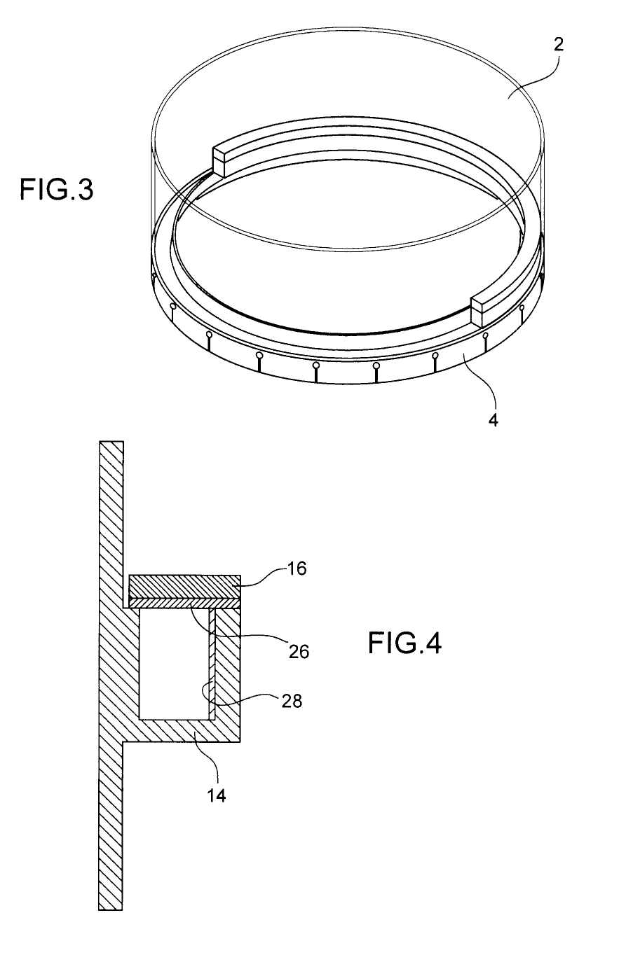

FIG. 3 is a perspective view of the device in FIGS. 1 and 2;

FIG. 4 is a detailed sectional view of the insulation of the cavity in which the heat source is located.

In FIG. 1, the reference 2 denotes a first part and the reference 4 denotes a second part. The first part 2 and the second part 4 are mechanically connected to each other in a connecting zone 6 to be separated. In the example embodiment described, the connecting zone is composed of pins 8 fixed to the second part 4 that engage in the corresponding holes in the first part 2. Screws, rivets or any other appropriate attachment means could be used instead of the pins 8. As can be seen particularly in FIG. 3, the first part 2 and the second part 4 are axisymmetric parts.

According to the invention, a heat source is applied to the first part 2. For example, the heat source 12 may be a commercial Thermite®. The heat source is housed inside a groove 14 fixed to the first part 2. The groove 14 is closed by an annular closing plate 16. The plate 16 may for example be made of 2 mm thick stainless steel. The plate 16 is held in place by a plate 18 folded at its end. The plate 18 may for example be a 1 mm thick stainless steel plate. A plate 20 fixed onto the first part 2 by rivets 22 bears on the closing plate 16. The plate 20 may for example be a 2 mm thick aluminium plate.

FIG. 2 shows an elevation view of the device shown in FIG. 1. This figure shows insertion of the second part 4 in the first part 2. A cutaway view on the left of the figure shows the heat source 12 applied to the first part.

Splices 24 in the first part 2 can also be seen in FIG. 2 that will facilitate its deformation during the heat stimulus.

For example, the heat source 12 may be a commercial Thermite® with a calorific value equal to at least 850 cal/g. The Thermite® is ignited with off-the-shelf initiators. These initiators are either mixed with Thermite® in the proportion by mass of one part of initiator for 3 to 4 parts of Thermite®, or placed in the groove adjacent to the Thermite® in the same proportion. The Thermite®/initiator assembly is ignited with initiators, for example electrical fireworks initiators. The number of electrical initiators necessary depends on the length of the separation zone.

The cavity in which the heat source is housed is thermally insulated on at least two sides such that the heat flow is oriented in the required direction. FIG. 4 shows a detailed sectional view of the insulation of the cavity in which the heat source is located. The cavity is insulated at the top and at the right such that the heat flux is directed downwards and towards the left of the cavity. The stainless steel plate 16 is doubled up by a layer of Prosial® 26 and the groove 14 is insulated on the right part as shown in the figure, for example by a mica sheet 28. The function of the thermal insulation procured by the layer of Prosial® and the mica sheet preferentially results in fast heating of the part 2 at the connection zone 6.

The device according to the invention operates as follows. Separation is initiated by fast heating of the first part 2. This means that a transient temperature regime is in place, with strong temperature variations that are the basic principle on which the invention operates. One consequence of these thermal non-uniformities is that the first part 2 deforms as shown by the deformed shape 30 in FIG. 1 because its right side is closer to the heat source than the left side. Consequently, the connection zone 6 to be separated is stressed in an appropriate direction. In other words, when the heat stimulus is applied, the first part 2 and the lower part 4 effectively move apart. This occurs because the connecting zone to be separated is on the hot side of the first part 1 that is stressed by the heating composition 12. This is an essential condition for operation of the invention. If the connecting zone to be separated were on the cold side of the part 1 stressed by the heating thermal composition 12, the parts to be separated would be squeezed together instead of moving apart and binding would increase, making separation impossible.

This insulation is made with materials with the lowest possible diffusivity, the order of magnitude of the diffusivity being λ/ρ.Cₚ. λ is the conductivity of the material, ρ its density and Cₚ its calorific value. This diffusivity characterises the capacity of an insulation to limit heat transfers under transient conditions.

Note also that the cavity must be gas tight for the invention to operate correctly.

FIG. 1 shows a mechanical connection by pins 8. However, the connection could also be made by any other means, for example by gluing or brazing. Brazed connections advantageously use materials with a low melting point. Glued connections will preferably use the Rescoll Company's INDAR gluing method with controlled separation.

With a connecting geometry like that defined in the invention, the result obtained for a Thermite® mass of 1.1 g/cm was an advance rate of the heat stimulus of more than 100 mm/s and possibly up to 4000 mm/s and a temperature rise in the connecting zone 6 of 300° C. in 1.4 seconds. Separation took place in less than 2 seconds. However, this duration is not unacceptable for the separation of stages, space probes, etc. All that is necessary is to adapt separation and propulsion sequences accordingly.

The invention was initially developed for the separation of launcher stages. But it could also be applicable to all cases in which linear separations occur, for example in the field of releasing satellites.

The invention may also be applicable in the fields of aeronautical, land or maritime equipment, for connections that must resist mechanical and thermal loads and be broken subsequently.

1-13. (canceled)

14. A separation device for smooth linear separation between a first part and a second part, the first part being connected to the second part, comprising:
a heat source applied onto the first part that applies a heat stimulus to the first part, so as to separate the first part from the second part by thermal deformation of the first part,
wherein the first part is linearly connected along a line to the second part and the heat source is applied linearly along a line onto the first part.

15. The separation device according to claim 14, wherein the heat source is placed in a gas tight cavity with sides comprising thermal insulation on at least two sides of the cavity.

16. The separation device according to claim 15, wherein the thermal insulation is made with materials with lowest possible diffusivity, the diffusivity being of magnitude λ/ρ·Cₚ in which λ is the conductivity of the material, ρ is its density, and Cₚ is its calorific capacity.

17. The separation device according to claim 16, wherein the thermal insulation is made of mica.

18. The separation device according to claim 14, wherein the heat source is a heating chemical composition.

19. The separation device according to claim 18, wherein the heating chemical composition is a commercial Thermite with a calorific value of at least 850 cal/g.

20. The separation device according to claim 14, wherein the first part is separated from the second part within a time less than 10 seconds.

21. The separation device according to claim 14, wherein the first part is separated from the second part within a time less than 3 seconds.

22. The separation device according to claim 14, wherein the first part is an axisymmetric part and the second part is a cylinder linearly connected to the first part by pins at a spacing from each other, by detachable gluing or by brazing.

23. The separation device according to claim 22, wherein the first part comprises splices that facilitate its deformation.

24. A soft linear method for separating a first part from a second part, the first part being linearly connected to the second part, the method comprising:
applying a heat source onto the first part; and
heating the first part by the heat source so as to be deformed by the heat source thermally and to separate from the second part.

25. The method according to claim 24, in which the first part is an axisymmetric part and the second part is a cylinder linearly connected to the first part by pins at a spacing from other, or by detachable gluing or brazing.

26. Application of a device according to claim 14 to space launchers, space probes, satellites, and missiles.
